(19) United States
(12) Patent Application Publication
(10) Pub. No.: US 2014/0278492 A1
(43) Pub. Date: Sep. 18, 2014

(54) SYSTEM AND METHODS FOR PROVING MEDICAL CARE ALGORITHMS TO A USER

(71) Applicant: Tahoe Institute of Rural Health Research, LLC, Truckee, CA (US)

(72) Inventors: Larry Silver, San Luis Obispo, CA (US); Artin Matousian, Truckee, CA (US)

(73) Assignee: Tahoe Institute of Rural Health Research, LLC, Truckee, CA (US)

(21) Appl. No.: 14/204,876

(22) Filed: Mar. 11, 2014

Related U.S. Application Data
(60) Provisional application No. 61/778,269, filed on Mar. 12, 2013.

(51) Int. Cl. G06F 19/00

(52) U.S. Cl. CPC G06F 19/3443; G06F 19/3406
USPC 705/2

(57) ABSTRACT

The use of a medical care algorithm in clinical care reduces the number of mistakes made in treating a patient. The use of a medical care algorithm in clinical care also increases the confidence of a health care provider in providing care for a patient. The invention provides a system and a method for effectively, thoroughly, and easily granting a health care provider with real-time access to critical, semi-critical, and non-critical medical care algorithms. The invention also provides a system and a method for a health care provider to consult proactive guidelines commonly used in health care. The invention also allows the health care provider a method to utilize the algorithms as a refresher tool for review and continuing education. Furthermore, the invention provides a method for the documentation of algorithm based treatments as an electronic medical record.

### CROSS REFERENCE

This application claims the benefit of U.S. Provisional Application No. 61/778,269, filed on Mar. 12, 2013, the contents of which is incorporated by reference in its entirety.

### BACKGROUND

Medical care algorithms have been developed to support physicians in carrying through specific standard-of-care health care protocols and to meaningfully reduce medical errors by offering physician(s), nurse(s), and supporting health care personal an overview of a diagnostic or treatment process that a clinician should follow for a certain type of patient, illness, or clinical circumstance. Access to medical care algorithms can improve the work flow of attending physicians, specialists, nurses, interns, and can improve the accuracy, swiftness, and overall delivery of medical care. However, health care facilities are commonly configured such that the emergency department, operating rooms, medical/surgical units, hospital treatment rooms, and doctor offices are insufficiently equipped with copies of all necessary medical care algorithms. In addition, the available hard copies of medical care algorithms are not habitually updated, and therefore may not reflect recent treatment developments.

Although medical care algorithms can sometimes be found on the internet, reliance on the ability to find, access, and retrieve a medical care algorithm from an internet source is a dangerous and ineffective practice, which frequently depends on the ability to apply data originated from unverified and unqualified sources to the care of a patient. Such deficiencies adversely affect the delivery of care to individual patients, and compromise a physician's ability to appropriately care for a patient(s). Furthermore, hard copies of a medical care algorithm provide no mechanism to ensure that a physician has acknowledged every step outlined by the medical care algorithm while applying the algorithm to the care of a patient.

### SUMMARY OF THE INVENTION

In some embodiments, the invention provides a method of providing a medical care algorithm, the method comprising: a) providing access to a module on a computer system comprising a processor, the module being associated with a plurality of medical care algorithms, wherein the module displays to a user a plurality of selectable icons each independently associated with at least one medical care algorithm; b) determining that the user has selected at least one of the selectable icons, whereupon the processor searches a medical care algorithm database for a medical care algorithm associated with the selected icon to provide a selected medical care algorithm; c) recording by the computer system that the selected icon has been selected, wherein the recording provides an electronic medical record of the accessing; and d) displaying on a display at least a portion of the selected medical care algorithm.

In some embodiments, the invention provides a computer program product comprising a computer-readable medium having computer-executable code encoded therein, the computer-executable code adapted to be executed to implement a method for providing a medical care algorithm, the method comprising: a) providing a medical care algorithm management system, wherein the medical care algorithm management system comprises: i) a display module; ii) a detecting module; iii) a search module; and iv) an output module; b) displaying to a user by the display module a plurality of selectable icons, wherein each selectable icon is independently associated with a medical care algorithm; c) detecting by the detecting module that a selectable icon has been selected by the user, wherein the selected icon has an identity; d) searching, based on the identity of the selected icon, by the search module a database of medical care algorithms, wherein the search identifies an identified medical care algorithm associated with the selected icon; and e) outputting by the output module the identified medical care algorithm.

In some embodiments, the invention provides a method of providing a medical care algorithm, the method comprising: a) receiving by a computer system a request, wherein the computer system comprises a processor; b) searching by the processor based on the request a database of medical care algorithms, thereby identifying at least one medical care algorithm associated with the request; c) recording by the computer system the identified medical care algorithm, wherein the recording provides an electronic medical record of the request; and d) displaying at least a portion of the identified medical care algorithm.

In some embodiments, the invention provides a method of accessing a medical care algorithm, the method comprising: a) accessing, by a user, a module comprising at least one medical care algorithm, wherein the module is accessed from a computer system comprising a processor; b) navigating the medical care algorithm within the module by selecting at least one selectable icon, wherein the processor provides an electronic medical record based on the selection; and c) viewing at least a portion of the medical care algorithm in a display

### BRIEF DESCRIPTION OF THE FIGURES

FIG. 1 illustrates a representative home icon of the invention.

FIG. 2 is a flow chart illustrating representative steps followed by a user when navigating a medical care algorithm provided by the invention.

FIG. 3 is a block diagram illustrating a first example architecture of a computer system that can be used in connection with example embodiments of the present invention.

FIG. 4 is a diagram illustrating a computer network that can be used in connection with example embodiments of the present invention.

FIG. 5 is a block diagram illustrating a second example architecture of a computer system that can be used in connection with example embodiments of the present invention.

FIG. 6 illustrates a global network that can transmit a product of the invention.

FIG. 7 illustrates a representative interface of a Ventricular Tachycardia critical care algorithm provided by the system of the invention.

FIG. 8 illustrates a representative full window representation of a branched Ventricular Tachycardia critical care algorithm provided by the system of the invention.

FIG. 9 illustrates a representative full window representation of a branched Malignant Hyperthermia algorithm provided by the system of the invention.

FIG. 10 illustrates representative selectable icons illustrating representative non-critical algorithms.

FIG. 11 illustrates representative selectable icons illustrating representative practical parameters in health care.

FIG. 12 illustrates representative parameters that can form a medical record of a critical event.

FIG. 13 illustrates representative parameters that can form a code blue medical record.

FIG. 14 illustrates a representative interface of a medical care algorithm of the invention.

FIG. 15 illustrates a representative interface of a medical care algorithm of the invention.

FIG. 16 illustrates a representative interface of a medical care algorithm of the invention.

FIG. 17 illustrates a representative interface of a medical care algorithm of the invention.

### DETAILED DESCRIPTION

The management of a subject in a hospital setting is a complex undertaking. In treating subjects, clinicians are confronted with memorizing and recalling in detail multiple and often complex treatment algorithms. Most clinicians use only a small subset of medical care algorithms routinely, yet many clinicians, particularly clinicians practicing emergency and critical care, are expected to remember and correctly perform every step of a medical care algorithm upon request.

The ability of a clinician to recall and follow the steps of a medical care algorithm can have a substantial impact in the life of a subject, yet, during a crisis, stress can impair a clinician's ability to recall, and apply a standard-of-care protocol, particularly if the protocol requires putting into practice steps of a medical care algorithm that have not been used or reviewed frequently. Furthermore, during a medical emergency, decisions regarding the care of a subject are often conducted within short periods of time, and therefore require both speed and accuracy from a clinician(s) and the clinical personnel treating the subject.

Clinicians face the challenge of internalizing and recalling several medical care algorithms they are expected, and occasionally required to implement. The system and methods of the invention described herein provide easy and convenient access to a plurality of medical care algorithms at the selection of an icon. A clinician can access, retrieve, acknowledge, and record in a medical record the steps of critical, semi-critical, non-critical, pediatric, and specialty-specific medical care algorithms used in the treatment of a subject, simply by selecting at least one selectable icon provided by the invention. A clinician can also use the system and methods of the invention to access and review a series of standard medical parameters that normally guide standard-of-operation protocols used in routine medical appointments, initial primary care appointments, initial specialty care appointments, acute appointments, subject follow-up appointments, procedure appointments, and appointments with multiple subjects.

Furthermore, many medical care algorithms currently available to clinicians are designed as study review materials for medical courses, and are therefore not formatted for actual use during a crisis. Medical care algorithms designed as study materials can be overly comprehensive, and such algorithms can often be formatted as small booklets, which are hard to navigate. As a consequence, the layout of many existing accredited algorithms is generally not readily applicable for use as a reference in real-life clinical treatments. Nonetheless, clinicians do not always have easy and fast access to medical care algorithms, in any format, layout, or design. An anesthesiologist can work in a hospital where, for example, the most commonly used critical care algorithm provided by the Advanced Cardiovascular Life Support (ACLS) association, is presented as a flow chart that is affixed as a poster to the wall of a treating room. The same anesthesiologist can also work in a different hospital where the same critical care algorithm provided by ACLS only exists within a Handbook of Emergency Care provided by the ACLS. The ACLS Handbook of Emergency Care can be available in a treating room utilized by the anesthesiologist or not available at all.

Several medical care algorithms are specialty specific, and there is no uniform organization or presentation format used to provide such algorithms in a clinical environment. A clinician can be familiarized with, for example, the design and format of a critical care algorithm provided to the clinician during residence training, and the clinician can be provided with a different design and format of the same critical care algorithm as an attending clinician. There exists a need to provide the information comprised within a medical care algorithm to a physician in a comprehensible, consistent, concise, clear, easily-available, rapidly available, and uniform credited format.

The present invention offers more than efficient access to medical care algorithms, the invention can also provide a check-point system to ensure that every aspect of a medical care algorithm is considered and acknowledged when treating a subject. In some embodiments, the invention further comprises a navigation and an acknowledgement module that allows a treating physician, or another member of a treating clinical team, to navigate different branches of a medical care algorithm. With the selection of an icon, a physician, a physician assistant, a nurse, or a plurality of other members of the treating clinical team can: a) confirm the methods selected in treating a subject; and b) upload the treatment information to a medical record associated with the subject. A physician, for example, working on an emergency medical code in an intensive care unit (ICU) can use the system and methods of the invention to access a standard-of-care medical algorithm that is relevant in treating the critical care code.

The invention offers a structured method to effectively and accurately fill a medical prescription that is associated with a course of treatment outlined by a selected medical care algorithm. In some embodiments, the invention provides an interface to at least one medicine dispensing system. The interface provides a system and method for a physician to submit a prescription to a medicine dispensing machine while consulting the medical care algorithm used in treating the subject. Medicine dispensing machines can be found in emergency rooms, operating rooms, doctors' offices, clinics, and other healthcare facilities. Medicine dispensing machines, for example, such as those sold by InstyMeds™, and Pyxis Carefusion™ are becoming ubiquitously present in the hospital setting, and the system and methods of the invention can provide an interface that greatly facilitates the convenience, promptness, and accuracy of filling a prescription. Medicine dispensing machines can hold about 100 of some of the most often used medications that can range from intravenously administered pharmaceuticals, oral capsules, to drops to creams. Filling a prescription with the system and methods of the invention promotes practicality and speed in the emergent health care setting.

In some embodiments, the system and methods of the invention provide an interface to a pharmacy. Medicine dispensing machines can offer a plurality of commonly-prescribed medications; however, some subjects can require prescription medications not offered by medicine dispensing machines. Some subjects can require counseling by a pharmacist on the use of a prescription medication. The interface of the invention provides a system and methods for a physician to submit a prescription to a pharmacy while consulting the medical care algorithm used in treating the subject.

The system and methods of the invention can: a) provide an electronic medical record that documents navigation of the medical care algorithm including the use of CPR or Shock Treatment by a user; b) provide an electronic or a pharmacy medical record documenting the submission of a prescription request to a medicine dispensing machine or to a pharmacy; and c) provide an electronic or a pharmacy medical record documenting the filling of a prescription request by a medicine dispensing machine or a pharmacy. All electronic records provided by the invention can include a time stamp, which documents the year, month, day, hour, minute, and second, when the electronic record was produced. In some cases, the systems and methods of the invention function as an interface to a separate Electronic Health Record system.

The invention allows health care providers to focus their time and energy on treating subjects rather than searching for a medical care algorithm, and similarly allows physicians to focus on health care improvements rather than reviewing medical care algorithms by ineffective means. Thus, the invention improves work flow and productivity.

### Medical Care Algorithms.

Clinicians are confronted with memorizing and then recalling in detail multiple and often complex medical care algorithms. A medical care algorithm can comprise a decision tree, a flowchart, a chart, a diagram, a schematic, a computation, a formula, a protocol, a list, a statistical survey, a nomogram, or a table. A medical care algorithm can be used in conjuncture with a medical treatment. A medical care algorithm can be used in conjuncture with a medical lecture.

Medical care algorithms can be applied in many medical settings, including the diagnosis, treatment/therapy, and prognosis steps of medical treatment. For example, a medical care algorithm can be used to support a physician's decision regarding a surgical procedure. A medical care algorithm can comprise distinct branches, and a physician can utilize personalized subject information, which can be displayed by the systems and methods of the invention alongside a medical algorithm, to decide which branch should be pursued in treating a subject. A medical care algorithm can comprise any chart, diagram, table, or schematic that supports a physician in recalling and selecting preferred standard-of-care steps in treating a subject. A subject can be, for example, elderly adults, adults, adolescents, pre-adolescents, children, toddlers, and infants. A subject can be, for example, an individual in need of critical care, semi-critical care, non-critical care, emergency care, surgery, or specialty specific care. A subject can be a patient.

A medical care algorithm can be accessed by a user on a computer system. A medical care algorithm can be, for example, displayed as a touch screen product. The system and methods of the invention can display on a touch screen interface at least one or a group of algorithms. The touch screen interface can be easily accessed at the site of care delivery, simple to use, and focused on a real-time application of the algorithm. A medical care algorithm can be associated with one, or a plurality of selectable icons. Selecting by the user at least one of the selectable icons alerts the computer system that the user selected the selectable icon that was selected, whereupon the computer system searches a medical algorithm database for a medical care algorithm associated with the selectable icon that was selected to provide a selected medical care algorithm, wherein the computer system comprises a processor, and the search is performed by a processor. The system and methods of the invention can display at least a portion of a selected medical care algorithm on, for example, the touch screen device.

A plurality of users can access a medical care algorithm using the system and method of the invention. A user can be, for example, a health care provider. A health care provider can be, for example, a physician. In some embodiments, the user is a health care provider attending the subject. Non-limiting examples of physicians and health care providers that can be users of the invention can include, an anesthesiologist, a bariatric surgery specialist, a blood banking transfusion medicine specialist, a cardiac electrophysiologist, a cardiac surgeon, a cardiologist, a certified nursing assistant, a clinical cardiac electrophysiology specialist, a clinical neurophysiology specialist, a clinical nurse specialist, a colorectal surgeon, a critical care medicine specialist, a critical care surgery specialist, a dental hygienist, a dentist, a dermatologist, an emergency medical technician, an emergency medicine physician, a gastrointestinal surgeon, a hematologist, a hospice care and palliative medicine specialist, a homeopathic specialist, an infectious disease specialist, an internist, a maxillofacial surgeon, a medical assistant, a medical examiner, a medical geneticist, a medical oncologist, a midwife, a neonatal-perinatal specialist, a nephrologist, a neurologist, a neurosurgeon, a nuclear medicine specialist, a nurse, a nurse practioner, an obstetrician, an oncologist, an oral surgeon, an orthodontist, an orthopedic specialist, a pain management specialist, a pathologist, a pediatrician, a perfusionist, a periodontist, a plastic surgeon, a podiatrist, a proctologist, a prosthetic specialist, a psychiatrist, a pulmonologist, a radiologist, a surgeon, a thoracic specialist, a transplant specialist, a vascular specialist, a vascular surgeon, and a veterinarian. The medical care algorithm could be viewed simultaneously by multiple users.

A medical care algorithm can comprise a critical care algorithm such as managment of a) anaphylaxis; b) difficult airway; c) supraventricular tachycardia; d) pulseless arrest; e) malignant hyperthermia; f) hypotensive shock; or a) massive transfusion. A subject suffering from a critical illness or an injury that acutely impairs one or more vital organ system's such that there is a high probability of imminent or life threatening deterioration in the subject's condition can be considered a critical care subject. Treatment of a critical care subject can involve complex subject assessment, subject manipulation, and intervention to prevent further life threatening deterioration of the subject's condition. Non-limiting examples of vital organ system failure include central nervous system failure, circulatory failure, shock, renal, hepatic, metabolic, and/or respiratory. A user of the invention can access a plurality of critical care algorithms. A user of the invention can select a critical care algorithm, and a user of the invention can apply treatment recommendations comprised within a medical care algorithm to the treatment of a subject. In some embodiments, a user of the invention can provide an emergency health care service to a subject. In some embodiments a medical care algorithm selected by a user and provided by the invention comprises an algorithm for performing a surgical procedure. In some embodiments, the system and method of the invention provide a medical care algorithm comprising a critical care algorithm.

A medical care algorithm can comprise a semi-critical care algorithm such as a) Pulmonary Embolism; b) Pneumothorax; c) CVA; d) ACS: e) local anesthetic toxicity; f) hypoxia; g) high regional block in OB; and h) bronchspasm. A plurality of clinical cases can be interpreted as semi-critical care cases. A plurality of procedures can be interpreted as semi-critical care procedures, even if the subject receiving the procedure is considered to be, for example, in a critical or in a stable condition. Common procedures that can be considered semi-critical care procedures, and that can be supported by a semi-critical care algorithm include, for example, treatment of local anesthetic toxicity and elective electrical cardioversion. In some embodiments, the system of the invention can display relevant medical media with the medical care algorithm. For example, a live video from a video laryngoscope used during an endotracheal intubation can be displayed alongside a medical care algorithm comprising an endotrachael intubation. A live video from a video laryngoscope can display a real time example of the relevant cardiac arrhythmia. In some embodiments, the system and method of the invention provide a medical care algorithm comprising a semi-critical care algorithm.

A medical care algorithm can comprise pediatric advanced life support (PALS) care algorithms. Management of children often requires distinct medical care algorithms with age and weight specific protocols. For instance, the respiratory rate of an infant can range from about 30 to about 60 breaths per minute (breaths/min), of a toddler from about 24 to about 40 breaths/min, of a preschooler from about 22 to about 34 breaths/min, of a school-age child from about 18 to about 30 breaths/min, and of an adolescent from about 12 to about 16 breaths per minute. The sleeping heart rate of a newborn to 3 month old baby can range from about 80 to about 160 beats per minute (rate/min), of a 3 month to 2 year-old child from about 75 to about 160 rate/min, of a 2 year-old to 10 year-old child from about 60 to about 90 rates/min, and the sleeping heart rate of an older child can range from about 50 to about 90 beats per minute. To facilitate the management of pediatric patients, a medical care algorithm of the invention can provide PALS specific algorithms. Pediatric algorithms can include, for example, a newborn resuscitation algorithm, a PALS pulseless arrest algorithm, a PALS bradycardia algorithm, a PALS tachycardia algorithm, and a pediatric BLS algorithm.

A medical care algorithm can comprise a non-critical care algorithm. A plurality of clinical cases can be interpreted as non-critical care cases. A plurality of procedures can be interpreted as non-critical care procedures, even if the subject receiving the procedure is considered to be, for example, in a critical or in a stable condition. Common procedures that can be considered non-critical care procedures, and that can be supported by a non-critical care algorithm include, for example, dialysis, hyperglycemia, bone density scans, treatment of infections, headache treatments, and stress tests for heart disease. For example, the management of hyperglycemia in a hospitalized subject can be considered non-critical. A hyperglycemic subject can be a diabetic subject whose treatment is being governed by pre-established insulin delivery algorithms. A user of the invention can apply a system of the invention to navigate a standard-of-care algorithm with recommendations for the treatment of a hospitalized hyperglycemic diabetic subject. The user of the invention can, for example, read and acknowledge by selecting a selectable icon a personalized recommended dosages of, for example, insulin, that is comprised within at least one displayed portion of the algorithm and that are personalized to, for example, the age, weight, or gender of the subject.

A medical care algorithm can comprise specialty or facility specific algorithms. Specialty specific algorithms can be specific to a field, or to a sub-field of medicine. Specialty specific medical care algorithms can comprise, for example, anesthesia, cardiology, endocrinology, gastroenterology, hematology, hepatology, nephrology, neurology, obstetrics, and a plurality of surgical algorithms. A nephrologist, for example, can treat a subject receiving hemodialysis. The nephrologist can be a user of the invention. The nephrologist can access a specialty specific medical care algorithm describing the standard-of-care in treating a hospitalized subject undergoing hemodialysis. The nephrologist can navigate a hemodialysis medical care algorithm and the nephrologist can incorporate the treatment decisions made while navigating a specialty specific algorithm to an electronic medical record associated with a subject by selecting a selectable icon. In some embodiments, the user can upload the navigating the treatment algorithm. This category can also include facility based information such as Color Code Lists.

A system of the invention can also provide access to general practice standards, facility, and procedure based protocols. Examples of general practice standards, facilities and procedure based protocols include: a) basic life support (BLS) review; b) a review of arrhythmias; c) crash cart navigation information; d) references to protocols; e) malignant hyperthermia cart navigation information; f) world alliance for patient safety (WHO) surgical safety checklist and implementation manual; operating room fire prevention algorithm; and g) code sheets.

A medical care algorithm can be customized to a subject based on at least one parameter associated with the subject. A plurality of parameters associated with a subject can be used to customize a medical care algorithm to a subject. For example, the weight of a subject can be used to customize the dosage of a pharmaceutical recommended as a course of treatment for a condition in a medical care algorithm. A subject's medical history, such as a history of allergic reactions to a medication, can be used to customize a medical care algorithm of a subject.

A system of the invention can be used to access a medical care algorithm from, for example, an emergency room, an operating room, a hospital crash cart, or an ambulance. In some embodiments, a system of the invention is a downloadable application, and a system of the invention can be downloaded to a computer system owned by a health care facility, such as a hospital, or a system of the invention can be downloaded to a computer system owned by a health care provider. A copy of the app could be downloaded and subsequently located on multiple devices operated by a facility.

### System of the Invention.

The invention provides one, or a plurality, of medical care treatment algorithms presented in an intuitive, pragmatic, and easily navigable format. A user can access the invention from a computer system and a user can visualize a Home Icon FIG. 1 101 of the invention in a display. A home icon of the invention can present a user with the option to access one or a plurality of selectable icons. Selecting of a selectable icon can be used as a method to navigate the algorithm. A Home Icon of the invention can comprise, for example, critical 102, semi-critical 103, and pediatric Advanced Life Support (PALS) 104 medical care algorithms. A home icon of the invention can also offer access to general practice standards and facility based protocols 105 in healthcare. In some embodiments, a selectable icon of the invention can be a touch screen icon.

The process of navigating a medical care algorithm by a user can start when a user accesses a system of the invention from a computer system FIG. 2. The user can access 201 the system of the invention by selecting a selectable icon. Selecting a selectable icon can be done, for example, by clicking a clickable icon, dragging and dropping an icon, sliding a selectable icon, or by voice recognition of an icon to a command. The user can navigate the system of the invention by, for example selecting one, or a plurality of selectable icons.

The user can select a group of algorithms 202, for example, a critical care group of algorithms, by selecting a selectable icon. The user can select an algorithm 203 within a group of critical care algorithms, for example, a hypoxia algorithm, by selecting a selectable icon. A system of the invention can receive the request submitted by a health care practitioner to access a medical care algorithm, and a system of the invention can display at least a portion of the medical care algorithm in a display. The user can navigate the hypoxia algorithm 204 by selecting on one, or a plurality of selectable icons describing the algorithm. In some embodiments, at least one step of the medical care algorithm is recorded in a medical record when a user selects a selectable icon of the invention.

A check-off or acknowledgement function can be required to move to a next step to insure that each step is completed and not skipped, and to provide documentation of the process. For example, selecting an icon associated with the medical care algorithm can be a check-off function, and selecting an icon can track a subject's progress through the identified medical care algorithm. Selecting an icon associated with the medical care algorithm can be recorded by a computer system in an electronic medical record. A user can be a physician 205, and a user can record at least one step of the medical care algorithm in a medical record when a user selects on a selectable icon of the invention. In addition, a system of the invention can determine the dosage of a pharmaceutical prescription to be prescribed to a subject based on personalized subject parameters such as subject weight and drug history. A user can submit a request for a prescription using a system of the invention 206.

A system of the invention can provide auditory guidance to a clinical procedure. In some embodiments, the system of the invention can recite audible steps of a medical care algorithm. The system of the invention can comprise a voice recognition module that uses, for example, a natural language user interface to recognize verbal commands from a clinician. A clinician can navigate a medical care algorithm of the invention by speaking commands, and a system of the invention can recognize verbal commands. In some embodiments, a clinician can acknowledge performing a step of a medical care algorithm with a verbal command. The system can audibly count out the pace of chest compressions or ventilations as required for cardiopulmonary resuscitation.

A system of the invention can provide visual guidance to a clinical procedure. A medical care algorithm of the invention can be accompanied by, for example, a metronome displaying the heartbeat of a subject. A medical care algorithm of the invention can be accompanied by, for example, a representative image of a subject undergoing a specified procedure. For example, a clinician that is performing a difficult intubation procedure can use a system of the invention to visualize a picture or a video of an intubation protocol. A clinician that is determining the best motor response of a child on a Modified Glasgow Coma Scale can find it useful to visualize reference images or videos of children with a range of motor responses scored on a similar scale. A clinician can navigate a medical care algorithm of the invention that is supplemented with representative images of the described treatment.

A system of the invention can be accessed from an operating room, an emergency room or from a hospital crash cart. A system of the invention can also provide documentation of an action taken, a medication prescribed, and/or a medication administered in the care of a subject. A system of the invention can interface with an electronic medical record or a pharmacy medical record to provide a record of treatment. This system is can provide an Electronic Health Record (EHR) of events that were acknowledged.

An Electronic Health Record provided by a system of the invention can be annotated with, for example, a medical treatment code. A medical treatment code can include an ICD (International Classification of Diseases) code; a CPT (Current Procedural Terminology) code; a National Drug (NDC) code; a psychiatric illness code, such as the DSM-IV-TR code; a Diagnosis Related Group (DRG) code; a disability code, such as an ICF (international Classification of Function) code; a HCPCS (Healthcare Common Procedure Coding System) code; a Medicare specific code; a Medicaid specific code; or a code that is specific to a group or a hospital, such as an insurance specific code or a hospital specific code. A system of the invention can, for example, transmit a prescription electronically to a pharmacy and associate the prescribed medication with an ICD code, a NDC code, or both.

### Interface to an Electronic Health Record (EHR).

The present invention pertains to a system and a method for providing a medical care algorithm to a user. A user can be a health care provider. The health care provider can be for example, a surgeon. The surgeon can access a medical care algorithm that is relevant to the treatment of the subject on a computer system, and the surgeon can select on a plurality of selectable icons as the surgeon reads, acknowledges, and navigates the medical care algorithm.

The surgeon can be attending a critical-care, a semi-critical care, and a non-critical care subject. The surgeon can navigate a critical care, a semi-critical care, and a non-critical medical care algorithm to support the care of the subject. The surgeon can be a specialist in a field, for example, the surgeon can be a cardiac surgeon or a neurosurgeon. The surgeon can navigate a specialty specific, such as a cardiovascular surgery based algorithm, to support the care of a subject.

In some embodiments, the medical care algorithm management system further provides a method for incorporating medical information in an electronic medical record whilst a user navigates a selected medical care algorithm. For example, a user can navigate a medical care algorithm associated with a subject by selecting at least one selectable icon on a computer system, and the computer system can provide an electronic medical record of the process. The user can be a physician attending the subject, and the system and methods of the invention can associate the steps of a critical care algorithm navigated by a physician with a medical record associated with the subject. As the physician navigates the algorithm by selecting on at least one of the selectable icons in the selected algorithm, an EHR record can be generated and provided. In some embodiments, progress is recorded in an electronic medical record as a user navigates an algorithm provided by the invention. The EHR can be hosted on the same computer system as the software of the invention, or on another computer.

An electronic medical record can comprise one or a compilation of documents describing medical information of a subject. An electronic medical record can comprise the complete medical history and care of a subject across a period of time, or an electronic medical record can comprise a single event in a subject's medical history. An electronic medical record can describe major and minor diseases, a surgical history, an obstetric history, medications and medical allergies, family history, social history, habits, immunization history, growth and developmental history.

A subject's electronic medical record can refer to a medical history of what has happened to the subject since birth. For example, medical history can be a record of diseases, major and minor illnesses, and/or growth landmarks. An electronic medical record can describe a chief complaint, a history of the present illness, a physical examination, an assessment of a clinical case, and a proposed course of action to treat a condition.

A subject's electronic medical record can comprise surgical history. Surgical history can describe surgery performed on a subject, for example, dates of operations, operative reports, and/or the detailed narrative of what a surgeon performed. In some embodiments, the present invention comprises a system and methods to provide a medical care algorithm to a user, wherein the medical care algorithm comprises a surgical procedure.

Pharmacy medical records (PMR) can relate to records pertaining to a subject's pharmacological history. Pharmacy medical records can be provided electronically. A subject's pharmacological history can comprise a subject's prescription history, current prescription regimen, and side effect information, for example, dosage information, length of time a subject has been taking a prescription, and other drugs known to cause negative side effects with a subject's current prescription regimen.

In some embodiments, the system of the invention comprises a computer program product, comprising a computer-readable medium having computer-executable code encoded therein, the computer-executable code adapted to be executed to implement a method for providing a medical care algorithm to a user, the method comprising providing a medical care algorithm management system, wherein the medical care algorithm management system comprises a display module, a detecting module, a search module and an output module. In some embodiments, the system further provides an interface to a medicine pharmaceutical dispensing machine. In some embodiments, the system further provides an interface to a pharmacy. In some embodiments, the system can provide a pharmacy medical record by interfacing with a medicine dispensing machine or a pharmacy.

Communications between a system of the invention, an EHR system, and a medicine dispensing machine can happen according to a plurality of communication protocols including, for example, hardwired, Wi-Fi, Bluetooth, user-datagram-protocol(s) (UDP), real-time-streaming-protocol(s) (RTSP), real-time-transport-protocol(s) (RTP), the real-time-transport-control-protocol(s) (RTCP), adaptative bitrate streaming, transmission-control-protocol(s) (TCP), and IEEE reliant protocols. In some embodiments, a health care provider can submit a prescription request to a medicine dispensing machine using a system of the invention. In some embodiments, a system of the invention and a medicine dispensing machine can share the same hardware platform.

A system and a method of the invention can document the administration and delivery of a pharmaceutical or therapeutic intervention to a subject. A medical record provided by the invention can be associated with a timestamp. A time stamp can indicate the year, day, hour, minute, and second a pharmaceutical or therapeutic intervention was administered to a subject. A time stamp can indicate the brand name, generic name, dosage, and treatment regimen administered in association with the treatment of a subject.

In some embodiments, a medical care algorithm management system further comprises a navigation module, wherein the navigation module comprises a recognition and/or acknowledgement icon, and wherein the navigation module further displays a subsequent step detecting that the acknowledgement icon has been selected. In some embodiments, selecting an acknowledgment icon can provide an electronic medical record associated with the completion of treatment of the subject. In some embodiments, selecting an acknowledgment icon can provide an electronic medical record indicating that a user has accessed the algorithm.

Electronic Medical Records (EMRs) can relate to records obtained and stored by a subject's doctor, clinician, insurance company, hospital and/or other facilities where a subject is a subject. In some embodiments, a health care provider can include a medical doctor, a dentist, an optometrist, a therapist, a chiropractor, and anyone who provides healthcare services to the subject. Electronic medical records (EMR) can comprise, for example, CAT scans, MRIs, ultrasounds, blood glucose levels, diagnoses, allergies, lab test results, EKGs, medications, daily charting, medication administration, physical assessments, admission nursing notes, nursing care plans, referrals, present and past symptoms, medical history, life style, physical examination results, tests, procedures, treatments, medications, discharges, history, diaries, problems, findings, immunizations, admission notes, on-service notes, progress notes, preoperative notes, operative notes, postoperative notes, procedure notes, delivery notes, and discharge notes.

A medical record provided by a system or methods of the invention can function as a self-sufficient or free standing electronic medical record. A medical record provided by a system and methods of the invention can be compatible with and easily interfaced with commercial electronic medical record systems. A medical record provided by a system and methods of the invention can be integrated with existing electronic medical records or non-electronic medical records of a subject.

In some embodiments, data delivery of an expert review of a medical record is compliant with the Health Insurance Portability and Accountability Act (HIPAA) standards.

The system and methods of the invention provide a medical care algorithm management system wherein the medical care algorithm management system comprises a display module, a detecting module, a search module, and an output module. The modules can display, detect, search, and output at least one identified critical care algorithm, semi-critical care algorithm, non-critical care algorithm, or a specialty specific algorithm. In some embodiments the algorithms can be branched algorithms. The system and methods of the invention can display a plurality of branch icons, wherein each branch icon is independently associated with a different branch of the identified medical care algorithm.

Medical media associated with a subject's electronic medical records can be displayed alongside a medical care algorithm identified by the invention. Health care providers, including attending physicians, specialists, nurses, and medical residents, can have access to medical media displayed by a system of the invention alongside a medical care algorithm. Personalized medical information associated with a subject's medical records can also be displayed alongside a medical care algorithm identified by the invention. In some embodiments, the medical care algorithm is customized based on individual parameters associated with the subject. In some embodiments, a parameter associated with the treated subject comprises the weight of the treated subject. In some embodiments, a parameter associated with the treated subject comprises the age of the treated subject. In some embodiments, a parameter associated with the treated subject comprises the gender of the treated subject.

In some embodiments, the invention comprises a system and a method for accessing recommendations within a medical care algorithm to support the treatment of a subject by a health care provider. In some embodiments, the medical care algorithm further comprises a medical imaging module. The medical imaging module can provide, for example, physicians, nurses, and specialist's access to medical images associated with a medical record of a subject in real-time. The medical media within the medical media module can be associated with at least one text description(s) detailing an existing reading or interpretation of the medical media. The medical images can be deprived of any prior reading or interpretation of the medical media. The medical media can be, for example, a real-time media visualization of an electrocardiogram of a subject in critical care, medical procedure or surgical technique.

In some embodiments, the system further provides an interface to a recording module. In some embodiments, the recording module provides an electronic medical record indicating that a user navigated a medical care algorithm when treating a subject. A user of the system can, for example, record at least one parameter associated with the treated subject in a recording module. In some embodiments, a user of the invention can submit a prescription request to a medicine dispensing machine based on the recorded at least one parameter associated with the treated subject. In some embodiments, a user of the invention can submit a prescription request to a pharmacy based on the recorded parameter associated with the treated subject. A system of the invention can, for example, associate a timestamp with the request.

This in turn could be interfaced with a larger Electronic Health record system also known as an Enterprise System. The data generated from the event could be shared between the two systems.

### Therapeutic Interventions.

The present invention provides a system and methods for accessing, retrieving, customizing, recording, and navigating medical care algorithms. In some embodiments, the invention provides a system and a method to direct a therapeutic intervention for a subject. In some embodiments, the suggested therapeutic intervention is customized to specific parameters associated with a subject. For example, the dosage of a therapeutic intervention can be customized to the weight of a subject. A type of medication, for example pediatric or adult medication, can be customized to the age of a subject. Certain interventions, for example, interventions prescribing estrogen or testosterone administration, can be customized to the gender of a subject.

A therapeutic intervention can be, for example, the administration of a pharmaceutical to a subject. A therapeutic intervention can be, for example, a preventive step in a procedure such as the precautionary administration of an antibiotic prior to surgery. A therapeutic intervention can be, for the example, a remediation step in an intervention such as the administration of a beta-blocker to a patient with heart disease. A therapeutic intervention can be suggested to a subject in connection with the navigation of a medical care algorithm. For example, a therapeutic intervention can be CPR or shock electrotherapy.

### Computer Architectures.

Various computer architectures are suitable for use with the invention. FIG. 3 is a block diagram illustrating a first example architecture of a computer system 300 that can be used in connection with example embodiments of the present invention. As depicted in FIG. 3, the example computer system can include a processor 302 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

As illustrated in FIG. 3, a high speed cache 301 can be connected to, or incorporated in, the processor 302 to provide a high speed memory for instructions or data that have been recently, or are frequently, used by processor 302. The processor 302 is connected to a north bridge 306 by a processor bus 305. The north bridge 306 is connected to random access memory (RAM) 303 by a memory bus 304 and manages access to the RAM 303 by the processor 302. The north bridge 306 is also connected to a south bridge 308 by a chipset bus 307. The south bridge 308 is, in turn, connected to a peripheral bus 309. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 309. In some architectures, the functionality of the north bridge can be incorporated into the processor instead of using a separate north bridge chip.

In some embodiments, system 300 can include an accelerator card 312 attached to the peripheral bus 309. The accelerator can include field programmable gate arrays (FPGAs) or other hardware for accelerating certain processing.

Software and data are stored in external storage 313 and can be loaded into RAM 303 and/or cache 301 for use by the processor. The system 300 includes an operating system for managing system resources; non-limiting examples of operating systems include: Linux, Windows™, MACOS™, BlackBerry OS™, iOS™, Google Jelly Bean and other functionally-equivalent operating systems, as well as application software running on top of the operating system.

In this example, system 300 also includes network interface cards (NICs) 310 and 311 connected to the peripheral bus for providing network interfaces to external storage, such as Network Attached Storage (NAS) and other computer systems that can be used for distributed parallel processing.

FIG. 4 is a diagram showing a network 400 with a plurality of computer systems 402a, and 402b, a plurality of cell phones and personal data assistants 402c, and Network Attached Storage (NAS) 401a, and 401b. In some embodiments, systems 402a, 402b, and 402c can manage data storage and optimize data access for data stored in Network Attached Storage (NAS) 401a and 402b. A mathematical model can be used for the data and be evaluated using distributed parallel processing across computer systems 402a, and 402b, and cell phone and personal data assistant systems 402c. Computer systems 402a, and 402b, and cell phone and personal data assistant systems 402c can also provide parallel processing for adaptive data restructuring of the data stored in Network Attached Storage (NAS) 401a and 401b. FIG. 4 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

FIG. 5 is a block diagram of a multiprocessor computer system using a shared virtual address memory space. The system includes a plurality of processors 501a-f that can access a shared memory subsystem 502. The system incorporates a plurality of programmable hardware memory algorithm processors (MAPs) 503a-f in the memory subsystem 502. Each MAP 503a-f can comprise a memory 504a-f and one or more field programmable gate arrays (FPGAs) 505a-f. The MAP provides a configurable functional unit and particular algorithms or portions of algorithms can be provided to the FPGAs 505a-f for processing in close coordination with a respective processor. In this example, each MAP is globally accessible by all of the processors for these purposes. In one configuration, each MAP can use Direct Memory Access (DMA) to access an associated memory 504a-f, allowing it to execute tasks independently of, and asynchronously from, the respective microprocessor 501a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 5, system on chips (SOCs), application specific integrated circuits (ASICs), or other processing and logic elements. For example, the Set Processor and Optimizer can be implemented with hardware acceleration through the use of a hardware accelerator card, such as accelerator card 312 illustrated in FIG. 3.

### Products of the Invention.

In some embodiments, the invention described herein comprises a computer program product adapted to provide access to a medical care algorithm. A product of the invention can be a medical care algorithm. A medical care algorithm can be, for example, produced and/or transmitted in a geographic location that comprises the same country as the user of the algorithm. A medical care algorithm can be, for example, produced and/or transmitted from a geographic location in one country and a user of the algorithm can be present in a different country. In some embodiments, the product of the invention is the computer program data product comprising a medical care algorithm that can be accessed and navigated by a user. In some embodiments, the data accessed by a system of the invention is a computer program product that can be transmitted from one of a plurality of geographic locations 601 to a user 602 (FIG. 6). Data from a medical care algorithm can be transmitted back and forth among a plurality of geographic locations, for example, by a network, a secure network, an insecure network, an internet, or an intranet. In some embodiments, a medical care algorithm is a physical and tangible product.

### EXAMPLES

### Example 1

### A Physician Utilizes the System and the Method of the Invention to Support the Treatment of a Subject in Critical Condition

A subject is admitted to a hospital. The subject has a pulse rate of more than 100 beats per minute, with at least three irregular heartbeats in a row. The subject is diagnosed with ventricular tachycardia by an attending physician. The attending physician accesses a system of the invention from a touch screen monitor in the operating room. The attending physician selects a home icon of the invention 101. The attending physician selects the critical care selectable icon 102. The attending physician seeks from a group comprising a plurality of critical care algorithms a Ventricular Tachycardia Algorithm (FIG. 7, 701). The attending physician selects the selectable icon comprising a Ventricular Tachycardia Algorithm.

The attending physician seeks information that supports treatment decisions made in attending the subject. The attending physician visualizes at least a portion of the Ventricular Tachycardia Algorithm in the touch screen monitor. The attending physician can go back 702 to a home icon, and the attending physician can visualize the type of algorithm he is navigating, in this case a critical care algorithm 703.

The attending physician visualizes actions that should be taken during subject evaluation 705. For example, the Ventricular Tachycardia Algorithm 701 can display a recommendation suggesting that the attending physician secure and verify airway and vascular access of the subject. The attending physician can visualize previous steps 704 that have been taken by either the attending physician, or by any member of a treating clinical team attending the subject. The attending physician can visualize actions that should be taken 706 during the course of treatment. Additionally, the attending physician can visualize real-time relevant medical media 707 and possible contributing factor 708 that are associated with the subject being treated and with a Ventricular Tachycardia diagnosis respectively.

As the attending physician navigates the Ventricular Tachycardia Algorithm 701 the physician visualizes at least a step 706, or at least a branch 706, of the Ventricular Tachycardia Algorithm. The attending physician can also select on an icon that supports a full screen visualization of a branched arrangement of the algorithm (FIG. 8, 801). As the physician navigates the Ventricular Tachycardia Algorithm with the system of the invention, at least one step of the branched or scroll arrangement of the algorithm 801 is displayed in the action 706 window.

The attending physician first visualizes a step recommending assisting subject breathing as needed 802, followed by a recommendation to take blood pressure, to begin working on an IV line, and to connect a subject to a cardiac monitor 803. The physician is prompted to evaluate the clinical case for serious signs or symptoms 804. The physician consults relevant medical media 707 and other information to make a decision. The physician is prompted to select a selectable icon displayed in the action 706 window that asks if the subject is stable 805 or unstable 815.

If the subject is stable 805, the physician is prompted to follow recommendations within the stable 805 branch of the algorithm. Some of the recommended courses of action can prompt the physician to determine the QRS type 806. If the QRS is a single QRS type 807, the attending physician can be prompted to determine if the subject will be treated 808 with 150 mg of Amiodarone given over a course of time of 10 minutes and repeated twice or 20 mg/min or procainamide. The physician can further interact with an interface of the invention that transmits a request by the attending physician to fill a prescription to an authorized medicine dispensing machine. The physician can be prompted to consider cardioversion 809 if the Ventricular Tachycardia persists. All steps can be visualized within an action 706 window of the invention or as a full window branched algorithm 801.

If the subject is stable 805, but the QRS type of the subject is polymorphic 810, the attending physician can be prompted to follow recommendations from a distinct branch of the algorithm. The attending physician can be prompted to request subject consultation by an expert 811, for example, a cardiologist specialist. The attending physician can be prompted to correct magnesium or electrolyte levels 812, and the attending physician can be prompted to consider pharmaceutical interventions personalized to the subject 813. The quantity and prescribed dosage of the pharmaceutical interventions 813 can be personalized by the system and methods of the invention to subject specific criteria, such as weight, age, and gender. The physician can be prompted to consider cardioversion 814 if the Ventricular Tachycardia persists. All of those steps can be visualized individually within an action 706 window of the invention or as a full view window branched algorithm 801.

If the subject is unstable 815, the physician is prompted to follow recommendations within the unstable 815 branch of the algorithm. The attending physician can be prompted to sedate the subject 816, and the attending physician can be prompted to perform non-synchronized shock if the QRS type is polymorphic 817. The attending physician can be prompted to cardiovert the subject 818. The recommended strength of voltage used cardioversion 818 can be personalized by the system and methods of the invention to subject specific criteria, such as weight, age, and gender. The attending physician can be prompted to prescribe a given dosage of a pharmaceutical 819, such as 150 mg of Amiodarone, to the subject. The quantity and prescribed dosage of the pharmaceutical interventions 819 can be personalized by the system and methods of the invention to subject specific criteria, such as weight, age, and gender. The physician can be prompted to consider a higher voltage of cardioversion 820 if the Ventricular Tachycardia persists. All steps can be visualized within an action 706 window of the invention or as a full window branched algorithm 801.

All steps of a critical care algorithm pursued by the attending physician can be saved to an electronic medical record associated with a subject. The attending physician can acknowledge pursuing a recommendation provided by a Ventricular Tachycardia Algorithm in treating a subject by selecting a selectable icon. All information can be saved to an electronic medical record or a pharmacy medical record associated with a subject.

### Example 2

### A Member of a Medical Care Team Utilizes the System and the Method of the Invention to Support the Emergency Care of a Subject

A subject is admitted to a hospital after a car accident. The subject is in critical condition and the subject is placed under general anesthesia. The subject develops Malignant Hyperthermia, a rare life-threatening condition that is usually triggered by exposure to certain drugs used for general anesthesia. Since Malignant Hyperthermia is a rare condition, the attending physicians, and hospital staff in the emergency room have not recently reviewed and do not recall the steps in a Malignant Hyperthermia medical care algorithm.

A member of a medical team attending the patient accesses a system of the invention from a touch screen monitor in the emergency room. The member of the medical team selects on a home icon of the invention 101. The member of the medical team selects the critical care selectable icon 102. The member of the medical team seeks from a group comprising a plurality of critical care algorithms a Malignant Hyperthermia Algorithm (FIG. 9, 901). The member of the medical team selects on the selectable icon comprising a Malignant Hyperthermia Algorithm.

The member of the medical team accesses a Malignant Hyperthermia Algorithm and visualizes at least a portion of the Malignant Hyperthermia Algorithm in a touch screen monitor. The member of the medical team recites the steps of the algorithm to the team: “upon suspicion of Malignant Hyperthermia 902 we should take the following immediate steps 903, stop triggering agents, remove vaporizer, double minute ventilation, start FiO2 1.0 with high fresh gas flow, start the patient on opioids, benzodiazepines, prepare Dantrolene, and take a blood sample. As secondary measures 904 we should extend monitoring, increase diuresis and prepare the postoperative intensive care unit. We should check to see if other serious signs or symptoms are present 905, such as hypermetabolism 906, and if yes 907, then we should start the patient on 2.5 mg/kg of dantrolene as an intravenous bolus, and if no 909 we should not prepare the dantrolene”.

### Example 3

### A Nurse Utilizes the System and the Method of the Invention to Review Practical Guidelines and Facility Based Protocols

A nurse seeks information that supports treatment decisions made in attending a subject. The nurse accesses the invention from a touch screen device in a hospital. The nurse selects a Home Icon of the invention FIG. 1, and selects practical guidelines and facility based protocols 105. The nurse visualizes a plurality of independent selectable icons (FIG. 10, 1001). The nurse reviews the icons describing non critical 1002 medical care algorithms, which include HTN crisis 1003, Bronchospasm 1004, Pulmonary Embolism 1005, Shock 1007, Tachycardia 1008, Ischemia 1009, Regional Analysis 1010, and a selectable link to a plurality of other algorithms 1006. The nurse selects the ischemia selectable icon and the nurse reviews the Ischemia medical care algorithm.

### Example 4

### A Medical Student Utilizes the System and the Method of the Invention to Review Practical Guidelines and Facility Based Protocols

A medical student seeks information that supports a medical learning process. The medical student accesses the invention from a personally owned touch screen device, such as an iPad™. The medical student selects on a Home Icon of the invention FIG. 1 and selects the practical parameters selectable icon 105 within a Home Icon of the invention. The medical student visualizes a plurality of independent selectable icons FIG. 11, 1101. The medical student reviews the icons describing practical parameters 1102 medical care algorithms, which include Defribrillation 1103, Aspiration 1104, Pneumothorax 1105, Edema 1106, Drug Error 1107, Arrythymias 1108, and a selectable link to a plurality of other algorithms 1109. The medical student selects the Aspiration selectable icon and reviews the Aspiration medical care algorithm.

### Example 5

### A Pediatrician Utilizes the System and the Method of the Invention to Access a Pediatric Advanced Life Support (PALS) Algorithm

A pediatrician is called to attend a four year-old child suffering from an apparent cardiac arrest. The pediatrician walks into a room where an emergency team has started CPR on the child. The pediatrician must quickly identify the cause of the cardiac arrest and treat the child. In children, cardiac arrest is usually not caused from a primary cardiac cause. Rather, the mechanisms of cardiac arrest in children typically involve progressive respiratory failure or shock (also called an asphyxial arrest), or ventricular fibrillation (VF)/pulseless ventricular tachycardia (VT). The pediatrician is unsure of the diagnosis and the pediatrician wants to identify possible differential diagnoses.

The pediatrician accesses a system of the invention from the touch screen of a tablet device. In addition to performing CPR, the medical team has provided oxygen, and connected the child to a monitor and a defibrillator. The pediatrician selects a home icon of the invention 101. The pediatrician selects the pediatric advanced life support selectable icon 104. The pediatrician selects a pediatric cardiac arrest algorithm. The system of the invention provides a list with possible differential diagnosis. Pediatric cardiac arrest often results from progressive respiratory failure or shock, also known as asphyxial arrest. Asphyxia begins with a variable period of systemic hypoxemia, hypercapnea, and acidosis, progresses to bradycardia and hypotension, and culminates with cardiac arrest. Another cause of pediatric cardiac arrest is ventricular fibrillation (VF) or pulseless ventricular tachycardia (VT). The pediatrician wants to identify the underlying cause for the cardiac arrest and the pediatrician wants to know what should be the next steps in treating this child.

The system of the invention proactively guides the pediatrician towards a correct diagnosis by prompting the physician to ask the right questions and provide acceptable standard-of-care treatment. Clinicians classify cardiac arrest into “shockable” versus “non-shockable”, as determined by the ECG rhythm. The system of the invention prompts the pediatrician navigating a pediatric cardiac arrest algorithm to first ask: “is the rhythm shockable?” The treatment for cardiac arrest is immediate defibrillation if a “shockable” rhythm is present, while cardiopulmonary resuscitation (CPR) supplemented with a dosage of epinephrine is used to induce a “shockable” rhythm if one is not already present. The pediatrician determines that the rhythm is not shockable and the pediatrician uses the voice command feature to engage with the system of the invention.

The pediatrician verbally provides a command to the system of the invention indicating that the rhythm is not shockable. The system of the invention recites audible instructions indicating to the physician that CPR should be performed every two minutes along with IV epinephrine every 3-4 minutes and the physician should consider an advanced airway treatment. Optionally, the system of the invention calculates the dosage of epinephrine to be administered based on the weight and/or age of the child. The system of the invention proactively provides audible instructions to every step in the pediatric cardiac arrest algorithm until the child is stabilized.

The pediatrician can be presented with parameters that can form a medical record of a critical event, as illustrated in FIG. 12. If appropriate, the pediatrician can be presented with representative parameters that can form a code blue medical record, as illustrated in FIG. 13.

### Example 6

### A System of the Invention Proactively Guides the Actions of a Clinician

A clinician is rotating in a new hospital. The clinician is unfamiliar with procedures that are specific to the new hospital. The new hospital provides portable touch screen devices comprising the system of the invention and the clinician accesses the invention from a touch screen. The clinician selects a Home Icon of the invention FIG. 1, and selects practical guidelines and facility based protocols 105. The clinician readily access protocols specific to that hospital from the portable device.

Meanwhile, the clinician is called to help with the difficult airway management of a subject. The clinician wants to review the standard-of-care steps in a difficult airway medical care algorithm. The system of the invention allows for rapid transition of one algorithm to another algorithm and the clinician quickly selects and transitions to a difficult airway critical care algorithm. The clinician sequentially navigates a graphical interface of the difficult airway algorithm on the portable device as illustrated in FIGS. 14-17. FIGS. 14-17 illustrate representative sequential graphical displays of a difficult airway medical care algorithm.

FIG. 14 illustrates the graphical interface visualized by the clinician. In FIG. 14 the clinician is prompted to access the likelihood and clinical impact of the basic management of four factors: a) difficult ventilation; b) difficult intubation; c) difficulty with patient cooperation or consent; and d) difficult tracheostomy. The clinician can acknowledge awareness of these instructions by clicking on the acknowledge button or by audibly reciting a verbal command. Subsequently, the system of the invention prompts the clinician to actively pursue opportunities to deliver supplemental oxygen throughout the process of difficult airway management (FIG. 15). The clinician can acknowledge awareness of these instructions by clicking on the acknowledge button or by audibly reciting a verbal command. The clinician is then prompted to consider the relative merits and feasibility of the following basic management choices: a) awake intubation versus intubation attempts after induction of general anesthesia; b) non-invasive technique for initial approach to intubation versus invasive technique for initial approach to intubation; c) video assisted laryngoscopy as an initial approach to intubation; or d) preservation of spontaneous ventilation versus ablation of spontaneous ventilation (FIG. 16).

The clinician determines that the best course of action is to consider the possibility of performing an awake intubation versus an intubation attempt after induction of general anesthesia. The clinician can acknowledge awareness of these instructions by clicking on the acknowledge button or by audibly reciting a verbal command. The clinician can continue navigating the algorithm by further visualizing primary and alternative strategies provided by the system of the invention or the clinician can return to a previous screen (FIG. 17). The system of the invention the can reset and refresh after navigation of each screen while storing a record of navigation on its memory.

### EMBODIMENTS

The following non-limiting embodiments provide illustrative examples of the invention, but do not limit the scope of the invention.

### Embodiment 1

A method of providing a medical care algorithm, the method of providing a medical care algorithm, the method comprising: a) providing access to a module on a computer system comprising a processor, the module being associated with a plurality of medical care algorithms, wherein the module displays to a user a plurality of selectable icons each independently associated with at least one medical care algorithm; b) determining that the user has selected at least one of the selectable icons, whereupon the processor searches a medical care algorithm database for a medical care algorithm associated with the selected icon to provide a selected medical care algorithm; c) recording by the computer system, that the selected icon has been selected, wherein the recording provides an electronic medical record of the accessing; and d) displaying on a display at least a portion of the selected medical care algorithm.

### Embodiment 2

The method of Embodiment 1, wherein the selected medical care algorithm comprises a critical care algorithm.

### Embodiment 3

The method of any one of Embodiments 1-2, wherein the selected medical care algorithm comprises a semi-critical care algorithm.

### Embodiment 4

The method of any one of Embodiments 1-3, wherein the selected medical care algorithm comprises a pediatric care algorithm.

### Embodiment 5

The method of any one of Embodiments 1-4, wherein the selected medical care algorithm comprises a procedure specific algorithm.

### Embodiment 6

The method of any one of Embodiments 1-5, wherein the selected medical care algorithm comprises an algorithm for performing a surgical procedure.

### Embodiment 7

The method of any one of Embodiments 1-6, further comprising recording at least one step of the medical care algorithm in a medical record by selecting a step icon associated with the step.

### Embodiment 8

The method of Embodiment 7, wherein the recording in the medical record records a time stamp.

### Embodiment 9

The method of any one of Embodiments 1-8, further comprising displaying relevant medical media.

### Embodiment 10

The method of any one of Embodiments 1-9, further comprising suggesting a therapeutic intervention for a subject, wherein the therapeutic intervention is related to the selected icon.

### Embodiment 11

A computer program product comprising a computer-readable medium having computer-executable code encoded therein, the computer-executable code adapted to be executed to implement a method for providing a medical care algorithm, the method comprising: a) providing a medical care algorithm management system, wherein the medical care algorithm management system comprises: i) a display module; ii) a detecting module; iii) a search module; and iv) an output module; b) displaying to a user by the display module a plurality of selectable icons, wherein each selectable icon is independently associated with a medical care algorithm; c) detecting by the detecting module that a selectable icon has been selected by the user, wherein the selected icon has an identity; d) searching, based on the identity of the selected icon, by the search module a database of medical care algorithms, wherein the search identifies an identified medical care algorithm associated with the selected icon; and e) outputting by the output module the identified medical care algorithm.

### Embodiment 12

The computer program product of Embodiment 11, wherein the identified medical care algorithm comprises a critical care algorithm.

### Embodiment 13

The computer program product of any one of Embodiments 11-12, wherein the identified medical care algorithm comprises a semi-critical care algorithm.

### Embodiment 14

The computer program product of any one of Embodiments 11-13, wherein the identified medical care algorithm comprises a pediatric care algorithm.

### Embodiment 15

The computer program product of any one of Embodiments 11-14, wherein the identified medical care algorithm comprises a specialty specific algorithm.

### Embodiment 16

The computer program product of any one of Embodiments 11-15, wherein the medical care algorithm management system further comprises a prescription interface to at least one medicine dispensing system, and wherein the method further comprises submitting by the prescription interface a prescription request to the medicine dispensing machine.

### Embodiment 17

The computer program product of Embodiment 16, wherein the electronic medical record further comprises a time stamp.

### Embodiment 18

The computer program product of any one of Embodiments 11-17, wherein the medical care algorithm management system further comprises a pharmacy interface to at least one pharmacy, and wherein the method further comprises providing an electronic medical record.

### Embodiment 19

The computer program product of Embodiment 18, wherein the electronic medical record further comprises a time stamp.

### Embodiment 20

The computer program product of any one of Embodiments 11-19, wherein the output module outputs a step of the identified medical algorithm.

### Embodiment 21

The computer program product of any one of Embodiments 11-20, wherein the medical care algorithm management system further comprises a navigation module, wherein the navigation module comprises an acknowledgement icon, and wherein the navigation module further displays a subsequent step upon detecting that the acknowledgment icon has been selected.

### Embodiment 22

The computer program product of Embodiment 21, wherein selecting the acknowledgement icon is required prior to outputting the subsequent step.

### Embodiment 23

The computer program product of Embodiment 21, wherein the navigation module comprises a plurality of branch icons, wherein each branch icon is independently associated with a different branch of the identified medical care algorithm, wherein the navigation module accesses a selected branch upon detecting that the branch icon associated with the selected branch has been selected.

### Embodiment 24

The computer program product of any one of Embodiments 11-23, wherein the method further comprises a recording module, wherein the recording module records at least one parameter associated with a subject.

### Embodiment 25

The computer program product of Embodiment 24, wherein the method further comprises customizing the identified medical care algorithm to the subject based on the recorded parameter.

### Embodiment 26

The computer program product of Embodiment 24, wherein the method further comprises submitting a prescription request to a medicine dispensing machine based on the recorded parameter.

### Embodiment 27

The computer program product of Embodiment 24, wherein the method further comprises submitting a prescription request to a pharmacy based on the recorded parameter.

### Embodiment 28

The computer program product of Embodiment 27, wherein the parameter associated with the treated subject is the weight of the treated subject.

### Embodiment 29

The computer program product of Embodiment 27, wherein the parameter associated with the treated subject is the age of the treated subject.

### Embodiment 30

The computer program product of Embodiment 27, wherein the parameter associated with the treated subject is the gender of the treated subject.

### Embodiment 31

The computer program product of any one of Embodiments 11-30, wherein the method further comprises outputting relevant medical media by the output module.

### Embodiment 32

A method of providing a medical care algorithm, the method comprising: a) receiving by a computer system a request, wherein the computer system comprises a processor; b) searching by the processor based on the request a database of medical care algorithms, thereby identifying at least one medical care algorithm associated with the request; c) recording by the computer system, the identified medical care algorithm, wherein the recording provides an electronic medical record of the request; and d) displaying at least a portion of the identified medical care algorithm.

### Embodiment 33

The method of Embodiment 32, further comprising tracking progress through the identified medical care algorithm.

### Embodiment 34

The method of Embodiment 33, wherein the progress is recorded in an electronic medical record associated with a subject.

### Embodiment 35

The method of any one of Embodiments 32-34, wherein at least a portion of the identified medical care algorithm is associated with a selectable icon.

### Embodiment 36

The method of Embodiment 35, wherein the selectable icon is a touch screen icon.

### Embodiment 37

The method of any one of Embodiments 32-36, further comprising displaying relevant medical media with the medical care algorithm.

### Embodiment 38

The method of any one of Embodiments 32-37, wherein the identified medical care algorithm is displayed on a mobile device.

### Embodiment 39

The method of any one of Embodiments 32-38, wherein the medical care algorithm comprises a critical care algorithm.

### Embodiment 40

The method of any one of Embodiments 32-39, wherein the medical care algorithm comprises a semi-critical care algorithm.

### Embodiment 41

The method of any one of Embodiments 32-40, wherein the medical care algorithm comprises a pediatric care algorithm.

### Embodiment 42

The method of any one of Embodiments 32-41, wherein the medical care algorithm comprises an emergency care algorithm.

### Embodiment 43

The method of any one of Embodiments 32-42, wherein the medical care algorithm comprises a surgical procedure.

### Embodiment 44

The method of any one of Embodiments 32-43, wherein the medical care algorithm comprises a specialty specific algorithm.

### Embodiment 45

The method of any one of Embodiments 32-44, further comprising recording at least one step of the identified medical care algorithm in a medical record.

### Embodiment 46

The method of any one of Embodiments 32-45, further comprising suggesting a therapeutic intervention for a subject, wherein the therapeutic intervention is related to the selected icon.

### Embodiment 47

A method of accessing a medical care algorithm, the method comprising: a) accessing, by a user, a module comprising at least one medical care algorithm, whereby the module is accessed from a computer system comprising a processor; b) navigating the medical care algorithm within the module by selecting at least one selectable icon, wherein the processor provides an electronic medical record based on the selection; and c) viewing at least a portion of the medical care algorithm in a display.

### Embodiment 48

The method of Embodiment 47, further comprising providing a therapeutic intervention to a subject based on the medical care algorithm.

### Embodiment 49

The method of Embodiment 47, wherein the user is a surgeon and does at least one of a)-c) in preparation for surgery.

### Embodiment 50

The method of Embodiment 47, wherein the user is a surgeon and does at least one of a)-c) during surgery.

### Embodiment 51

The method of any one of Embodiments 47-50, wherein the navigating further comprises submitting a prescription request to a medicine dispensing machine.

### Embodiment 52

The method of any one of Embodiments 47-51, wherein the wherein the navigating further comprises submitting a prescription request to a pharmacy.

What is claimed is:

1. A method of providing a medical care algorithm, the method comprising:
a) providing access to a module on a computer system comprising a processor, the module being associated with a plurality of medical care algorithms, wherein the module displays to a user a plurality of selectable icons each independently associated with at least one medical care algorithm;
b) determining that the user has selected at least one of the selectable icons, whereupon the processor searches a medical care algorithm database for a medical care algorithm associated with the selected icon to provide a selected medical care algorithm;
c) recording by the computer system that the selected icon has been selected, wherein the recording provides an electronic medical record of the accessing; and
d) displaying on a display at least a portion of the selected medical care algorithm.

2. The method of claim 1, wherein the selected medical care algorithm comprises a critical care algorithm.

3. The method of claim 1, wherein the selected medical care algorithm comprises a semi-critical care algorithm.

4. The method of claim 1, wherein the selected medical care algorithm comprises a pediatric care algorithm.

5. The method of claim 1, wherein the selected medical care algorithm comprises a procedure specific algorithm.

6. The method of claim 1, wherein the selected medical care algorithm comprises an algorithm for performing a surgical procedure.

7. The method of claim 1, further comprising recording at least one step of the medical care algorithm in a medical record by selecting a step icon associated with the step.

8. The method of claim 7, wherein the recording in the medical record records a time stamp.

9. The method of claim 1, further comprising displaying relevant medical media.

10. The method of claim 1, further comprising suggesting a therapeutic intervention for a subject, wherein the therapeutic intervention is related to the selected icon.

11. A computer program product comprising a computer-readable medium having computer-executable code encoded therein, the computer-executable code adapted to be executed to implement a method for providing a medical care algorithm, the method comprising:
a) providing a medical care algorithm management system, wherein the medical care algorithm management system comprises:
i) a display module;
ii) a detecting module;
iii) a search module; and
iv) an output module;
b) displaying to a user by the display module a plurality of selectable icons, wherein each selectable icon is independently associated with a medical care algorithm;
c) detecting by the detecting module that a selectable icon has been selected by the user, wherein the selected icon has an identity;
d) searching, based on the identity of the selected icon, by the search module a database of medical care algorithms, wherein the search identifies an identified medical care algorithm associated with the selected icon; and
e) outputting by the output module the identified medical care algorithm.

12. The computer program product of claim 11, wherein the identified medical care algorithm comprises a critical care algorithm.

13. The computer program product of claim 11, wherein the identified medical care algorithm comprises a semi-critical care algorithm.

14. The computer program product of claim 11, wherein the identified medical care algorithm comprises a pediatric care algorithm.

15. The computer program product of claim 11, wherein the identified medical care algorithm comprises a specialty specific algorithm.

16. The computer program product of claim 11, wherein the medical care algorithm management system further comprises a prescription interface to at least one medicine dispensing system, and wherein the method further comprises submitting by the prescription interface a prescription request to the medicine dispensing machine.

17. The computer program product of claim 16, wherein the electronic medical record further comprises a time stamp.

18. The computer program product of claim 11, wherein the medical care algorithm management system further comprises a pharmacy interface to at least one pharmacy, and wherein the method further comprises providing an electronic medical record.

19. The computer program product of claim 18, wherein the electronic medical record further comprises a time stamp.

20. The computer program product of claim 11, wherein the output module outputs a step of the identified medical algorithm.

21. The computer program product of claim 11, wherein the medical care algorithm management system further comprises a navigation module, wherein the navigation module comprises an acknowledgement icon, and wherein the navigation module further displays a subsequent step upon detecting that the acknowledgment icon has been selected.

22. The computer program product of claim 21, wherein selecting the acknowledgement icon is required prior to outputting the subsequent step.

23. The computer program product of claim 21, wherein the navigation module comprises a plurality of branch icons, wherein each branch icon is independently associated with a different branch of the identified medical care algorithm, wherein the navigation module accesses a selected branch upon detecting that the branch icon associated with the selected branch has been selected.

24. The computer program product of claim 11, wherein the method further comprises a recording module, wherein the recording module records at least one parameter associated with a subject.

25. The computer program product of claim 24, wherein the method further comprises customizing the identified medical care algorithm to the subject based on the recorded parameter.

26. The computer program product of claim 24, wherein the method further comprises submitting a prescription request to a medicine dispensing machine based on the recorded parameter.

27. The computer program product of claim 24, wherein the method further comprises submitting a prescription request to a pharmacy based on the recorded parameter.

28. The computer program product of claim 11, wherein the parameter associated with the treated subject is the weight of the treated subject.

29. The computer program product of claim 11, wherein the parameter associated with the treated subject is the age of the treated subject.

30. The computer program product of claim 11, wherein the parameter associated with the treated subject is the gender of the treated subject.

31. The computer program product of claim 11, wherein the method further comprises outputting relevant medical media by the output module.

32. A method of providing a medical care algorithm, the method comprising:
a) receiving by a computer system a request, wherein the computer system comprises a processor;
b) searching by the processor based on the request a database of medical care algorithms, thereby identifying at least one medical care algorithm associated with the request;
c) recording by the computer system the identified medical care algorithm, wherein the recording provides an electronic medical record of the request; and
d) displaying at least a portion of the identified medical care algorithm.

33. The method of claim 32, further comprising tracking progress through the identified medical care algorithm.

34. The method of claim 33, wherein the progress is recorded in an electronic medical record associated with a subject.

35. The method of claim 32, wherein at least a portion of the identified medical care algorithm is associated with a selectable icon.

36. The method of claim 35, wherein the selectable icon is a touch screen icon.

37. The method of claim 32, further comprising displaying relevant medical media with the medical care algorithm.

38. The method of claim 32, wherein the identified medical care algorithm is displayed on a mobile device.

39. The method of claim 32, wherein the medical care algorithm comprises a critical care algorithm.

40. The method of claim 32, wherein the medical care algorithm comprises a semi-critical care algorithm.

41. The method of claim 32, wherein the medical care algorithm comprises a pediatric care algorithm.

42. The method of claim 32, wherein the medical care algorithm comprises an emergency care algorithm.

43. The method of claim 32, wherein the medical care algorithm comprises a surgical procedure.

44. The method of claim 32, wherein the medical care algorithm comprises a procedure specific algorithm.

45. The method of claim 32, further comprising recording at least one step of the identified medical care algorithm in a medical record.

46. The method of claim 32, further comprising suggesting a therapeutic intervention for a subject, wherein the therapeutic intervention is related to the selected icon.

47. A method of accessing a medical care algorithm, the method comprising:
a) accessing, by a user, a module comprising at least one medical care algorithm, wherein the module is accessed from a computer system comprising a processor;
b) navigating the medical care algorithm within the module by selecting at least one selectable icon, wherein the processor provides an electronic medical record based on the selection; and
c) viewing at least a portion of the medical care algorithm in a display.

48. The method of claim 47, further comprising providing a therapeutic intervention to a subject based on the medical care algorithm.

49. The method of claim 47, wherein the user is a surgeon and does at least one of a)-c) in preparation for surgery.

50. The method of claim 47, wherein the user is a surgeon and does at least one of a)-c) during surgery.

51. The method of claim 47, wherein the navigating further comprises submitting a prescription request to a medicine dispensing machine.

52. The method of claim 47, wherein the navigating further comprises submitting a prescription request to a pharmacy.
